(19) United States
(12) Patent Application Publication
(10) Pub. No.: US 2007/0287562 A1
(43) Pub. Date: Dec. 13, 2007

(54) Hydraulic Tensioner For A Traction Mechanism Of An Internal Combustion Engine

(75) Inventor: Martin Assel, Burgbernheim (DE)

Correspondence Address: HEDMAN & COSTIGAN P.C., 1185 AVENUE OF THE AMERICAS, NEW YORK, NY, 10036, US

(73) Assignee: SCHAEFFLER KG, HERZOGENAURACH (DE)

(21) Appl. No.: 11/791,443

(22) PCT Filed: Oct. 18, 2005
(86) PCT No.: PCT/EP05/11163

§ 371 Date: Jun. 5, 2007

(30) Foreign Application Priority Data
Nov. 24, 2004 (DE) 10 2004 056 623.2

(51) Int. Cl. F16H 7/08

(52) U.S. Cl. 474/110

(57) ABSTRACT

The invention relates to a hydraulic tensioner for tensioning a traction mechanism of an internal combustion engine, having a housing in which are arranged a high-pressure space and a low-pressure space which are filled with oil and can be connected by means of a ball valve and a throttle gap.

A tensioner (1, 1′) which maintains the oil quality of its first filling for the longest possible time is provided in that the low-pressure space (12) is connected by means of a leakage oil line (15) to the ball valve (7) and by means of an external oil line (16) to an oil source, and in that another ball valve (17) is situated in the external oil line (16), which other ball valve (17) can be closed off in the direction of the oil source.

### FIELD OF THE INVENTION

The invention relates to a hydraulic tensioner for tensioning a traction mechanism of an internal combustion engine, in particular according to the preamble of Patent Claim 1.

### BACKGROUND OF THE INVENTION

DE 43 40 487 A1 describes a hydraulic tensioner for tensioning a traction mechanism of an internal combustion engine which has a housing in which are arranged a high-pressure space and a low-pressure space which are filled with oil and can be connected by means of a ball valve and a throttle gap.

The leakage oil which, in the above-described solution, originates from the high-pressure space, which is filled with clean oil of the first filling, and flows through the throttle gap into the low-pressure space, is mixed in said low-pressure space with the more or less contaminated engine oil of a spray oil tank. From there, said leakage oil passes via the ball valve back into the high-pressure space, and in some circumstances adversely affects the impermeability and function of the ball valve.

### OBJECT OF THE INVENTION

The invention is based on the object of providing a hydraulic tensioner in which the oil quality of the first filling is maintained for the longest possible time.

### SUMMARY OF THE INVENTION

The object is achieved according to the invention by means of the features of independent Device Claim 1.

Since the low-pressure space is outwardly closed off, the leakage oil of the high-pressure space which emerges from the throttle gap can circulate via the low-pressure space, the leakage oil line and the ball valve back to the high-pressure space. Here, the leakage oil does not at any point come into contact with contaminated external oil. Said leakage oil thereby remains in the clean state of the first filling. Only in the event of oil loss does external oil pass via the second ball valve and the external oil line into the leakage oil circuit. In this case, the leakage oil becomes increasingly contaminated, but the tensioner remains filled with oil, and thereby functional, even in the event of leakage.

It is advantageous if the oil source is a lubricating oil pump of the internal combustion engine. In this way, the low-pressure space is acted on with the feed pressure of the lubricating oil pump. As a result of the ball valve arranged in the external oil line, the tensioner cannot drain empty when the internal combustion engine is at standstill. Said tensioner instead remains at the feed pressure of the oil pump. In this way, the tensioner remains filled even at standstill, exhibits no oil foaming and is functional when the engine is next started.

If the oil source is embodied as a spray oil tank which is open at the top and is arranged above the low-pressure space, a separate oil supply line to the tensioner is dispensed with. Said tensioner is thereby completely independent from the oil supply of the internal combustion engine.

It is advantageous if a gas-filled equalizing chamber is provided which is flow-connected to the low-pressure space. In this way, a pressure rise in the low-pressure space as a result of the oil being forced out of the high-pressure space as the hollow piston dips into the sleeve and as a result of the temperature-dependent expansion of the oil is reduced. In addition, air from foamed oil can collect in the equalizing tank. As a result of its position above the low-pressure space, the equalizing tank cannot fill with oil.

### BRIEF DESCRIPTION OF THE DRAWINGS

Further features of the invention can be gathered from the following description and the drawings in which an exemplary embodiment of the invention is illustrated in schematized form.

In the drawings:

FIG. 1 shows a cross section through a hydraulic tensioner with a separate oil supply and an additional external oil supply via another ball valve by means of an oil pump of an internal combustion engine; and

FIG. 2 shows a hydraulic tensioner as in FIG. 1, but with an external oil supply via a spray oil tank.

### DETAILED DESCRIPTION OF THE DRAWINGS

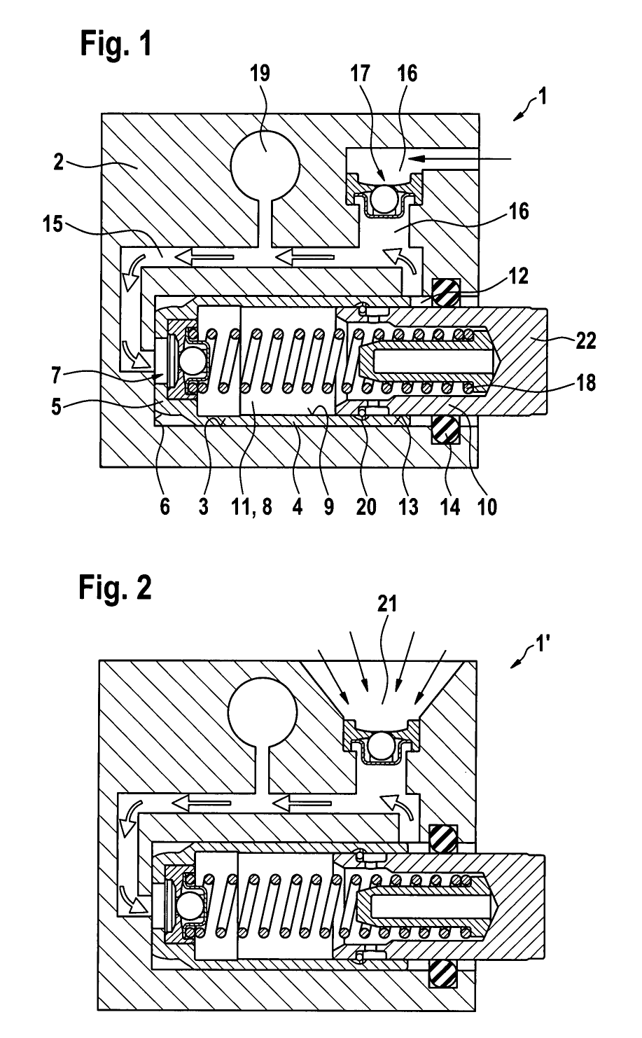

FIG. 1 illustrates a hydraulic tensioner 1 for tensioning a traction mechanism of an internal combustion engine. The traction mechanism is, for example, a tensioning belt.

The hydraulic tensioner 1 has a housing 2 with a blind hole 3 into which a sleeve 4 is inserted. The sleeve 4 has a sleeve base 5 which is in contact with a blind-hole base 6.

A ball valve 7 is arranged in the sleeve base 5, which ball valve 7 opens towards the sleeve interior 8. An inner bore 9 of the sleeve 4 serves as a guide for a hollow piston 10. The piston head 22 of said hollow piston 10 is situated at that end thereof which is remote from the sleeve. A throttle gap 13 is provided between the inner bore 9 and the hollow piston 10.

The sleeve 4 and the hollow piston 10 together enclose a high-pressure space 11. Arranged in the latter is a tensioning spring 18 which serves to pretension a traction mechanism. The reciprocating movement of the hollow piston 10 is limited by an axial stop 20.

A low-pressure space 12 is situated at the free end of the sleeve 4 or at the end of the throttle gap 13. Said low-pressure space is of annular design and is outwardly sealed off by means of a sealing ring 14.

The low-pressure space 12 is connected by means of a leakage oil line 15 and the ball valve 7 to the high-pressure space 11.

An external oil line 16 leads from an oil pump (not illustrated) of the internal combustion engine to the leakage oil line 15 via another ball valve 17.

A gas-filled equalizing space 19 is likewise connected to the leakage oil line 15. The tensioner according to the invention functions as follows:

This description proceeds from a tensioner 1 filled with clean oil. The high-pressure space 11, the low-pressure space 12, the leakage oil line 15, a part of the equalizing space 19 and that part of the external oil line 16 which is situated between the other ball valve 17 and the leakage oil line 15 are filled with oil. It is assumed that the ball valves 7 and 17 and the sealing ring 14 are functional and impermeable.

In addition, the internal combustion engine should be switched off. The oil pump of said internal combustion engine has, during engine operation, pumped the oil spaces of the low-pressure region (=the low-pressure space 12, the leakage oil line 15, part of the external oil line 16 and the equalizing space 19) with its feed pressure. Said feed pressure is maintained in the oil spaces of the low-pressure region even when the internal combustion engine is at standstill, since the other ball valve 17 prevents oil from flowing out into that part of the external oil bore 16 which drains empty. The oil pressure in the low-pressure region can, while the engine is at standstill, even rise as a result of an equalization of the high pressure in the high-pressure space 11 via the throttle gap 13. The other ball valve 17 according to the invention maintains the pilot pressure and thereby the functional readiness of the tensioner.

After the internal combustion engine is started, the reciprocating movement of the hollow piston 10, and thereby the circulation of the oil in the tensioner, begins as a result of the movements of the traction mechanism and as a result of the thermal expansion of the internal combustion engine and the traction mechanism. As the reciprocating piston 10 dips into the sleeve 4, the oil flows via the throttle gap 13 into the low-pressure space 12 and via the leakage oil line 15 into the equalizing space 19.

As the hollow piston 10 moves out of the sleeve 4, the oil flows out of the equalizing space 19 via the leakage oil line 15 and the ball valve 7, which is then open, back into the high-pressure space 11. During said oil circulation, as a result of the other ball valve 17 according to the invention, there is no contact with possibly contaminated engine oil, so that the oil quality of the first filling is maintained for a long time. Only once the sealing ring 14 wears and becomes permeable is the oil lost there replaced from the external oil line 16 via the other ball valve 17 which is then open. In this way, the contamination of the first filling is restricted to the lowest possible level.

The tensioner 1′ of FIG. 2 differs from that of FIG. 1 merely in that, instead of the oil pump (not illustrated), there is a spray oil tank 21 which is arranged above the leakage oil line 15 and is flow-connected to the external oil line 16. Said spray oil tank 21 makes a separate oil supply line to the tensioner 1′ unnecessary. Said spray oil tank 21 does, however, require the traction mechanism to be a lubricated chain which, on account of the spray oil, must operate in a closed chain case.

With a spray oil supply of the tensioner 1′, there is no possibility of a pilot pressure in the low-pressure region said tensioner 1′. With the exception of this difference, the function of the tensioner 1′ corresponds to that of the tensioner 1.

### LIST OF REFERENCE SYMBOLS

1, 1′ Hydraulic tensioner
2 Housing
3 Blind hole
4 Sleeve
5 Sleeve base
6 Blind-hole base
7 Ball valve
8 Sleeve interior
9 Inner bore
10 Hollow piston
11 High-pressure space
12 Low-pressure space
13 Throttle gap
14 Sealing ring
15 Leakage oil line
16 External oil line
17 Other ball valve
18 Tensioning spring
19 Equalizing space
20 Axial stop
21 Spray oil tank
22 Piston head

1. Hydraulic tensioner for tensioning a traction mechanism of an internal combustion engine, having a housing in which are arranged a high-pressure space and a low-pressure space which are filled with oil and can be connected by means of a ball valve and a throttle gap, characterized
in that the housing (2) has a blind hole (3) for a sleeve (4), having a sleeve base (5) which is in contact with a blind-hole base (6);
in that the ball valve (7) is arranged in the sleeve base (5), which ball valve (7) opens towards the sleeve interior (8),
in that the inner bore (9) of the sleeve (4) serves as a guide for a hollow piston (10) whose piston head (22) is situated on that end of the hollow piston (10) which is remote from the sleeve,
in that the sleeve (4) and the hollow piston (10) together enclose the high-pressure space (11), and the low-pressure space (12) is arranged at the end of the throttle gap (13), is preferably of annular design and outwardly sealed off;
in that the low-pressure space (12) is connected by means of a leakage oil line (15) to the ball valve (7) and by means of an external oil line (16) to an oil source, and
in that another ball valve (17) is situated in the external oil line (16), which other ball valve (17) can be closed off in the direction of the oil source.

2. Hydraulic tensioner according to claim 1, characterized in that the oil source is a lubricating oil pump of the internal combustion engine.

3. Hydraulic tensioner according to claim 1, characterized in that the oil source is a spray oil tank (21) which is open at the top and is arranged above the low-pressure space (12).

4. Hydraulic tensioner according to claim 1, characterized in that a gas-filled equalizing chamber (19) is provided which is arranged above the low-pressure space (12) and is flow-connected to the latter.
